(19) United States
(12) Patent Application Publication
(10) Pub. No.: US 2026/0072860 A1
(43) Pub. Date: Mar. 12, 2026

(54) DATA DIODE AND DATA TRANSFER ABNORMALITY NOTIFICATION METHOD

(71) Applicant: Azbil Corporation, Tokyo (JP)

(72) Inventors: ATSUSHI KATSUMATA, Tokyo (JP); Fumiaki YAMASAKI, Tokyo (JP); MAMORU KAGOURA, Tokyo (JP)

(73) Assignee: Azbil Corporation, Tokyo (JP)

(21) Appl. No.: 19/207,367

(22) Filed: May 14, 2025

(30) Foreign Application Priority Data
Sep. 11, 2024 (JP) 2024-157077

(51) Int. Cl. G06F 13/38

(52) U.S. Cl. CPC G06F 13/38; G06F 2213/40

(57) ABSTRACT

A transmission side device transmits data from an OT side device connected to an OT network. A reception side device transmits input data to an IT network. A one-way communication part transmits data transmitted from the transmission side device to the reception side device. The reception side device includes an abnormality detection part that detects the presence or absence of an abnormality in data transfer, and a reception side notification part that, based on the detected presence or absence of an abnormality in the data transfer, notifies the transmission side device of information indicating the presence or absence of an abnormality in the data transfer. The transmission side device includes a transmission side notification part that, based on the information indicating the presence or absence of an abnormality in the data transfer, if there is an abnormality in the data transfer, notifies the OT side device of the same.

### CROSS-REFERENCE TO RELATED APPLICATION

This application claims the priority benefit of Japan application serial no. 2024-157077, filed on Sep. 11, 2024. The entirety of the above-mentioned patent application is hereby incorporated by reference herein and made a part of this specification.

### BACKGROUND

### Technical Field

The disclosure relates to a data diode that performs one-way communication, and a data transfer abnormality notification method using a data diode.

### Related Art

An operational technology (OT) network (control network) employed in automation in a factory or the like is used for controlling various devices and is very important. If the OT network is maliciously hijacked, by making the control of the devices abnormal, accidents that are normally unlikely to happen may be caused.

Such a very important control network generally maintains security by not connecting to other networks.

On the other hand, there is a desire to use information or the like generated on the OT network externally, and a data diode is effective in such cases. This data diode enables communication in only one direction and is effective as a method for physically enhancing network security (see, for example, Japanese Patent Laid-Open No. 2015-133558). By this data diode, data can be sent in one direction from an OT side device connected to the OT network to an information technology (IT) side device connected to an IT network (business network).

In this way, since the data diode physically enables communication in only one direction, even if someone with malicious intent tries to hijack, there is no network through which to intrude. In order to guarantee the above in the data diode, it is not possible to provide an information transmission path in a reverse direction, even to a small extent.

In this way, in the data diode, since communication is enabled in only one direction, it is general that a transmission side is unable to obtain information from a reception side. By this data diode, it is almost possible to fully prevent unauthorized access.

On the other hand, in the data diode, it is not possible to respond to an ACK packet (response message from the reception side) used in connection-oriented communication such as TCP/IP, and it is also not possible to respond to error information. Hence, there is no choice but to assume that the transmission side always performs transmission normally.

As a result, even if a communication error occurs, since no retransmission is performed, data may be missing. To make up for the missing data, it is necessary to manually extract the missing data directly from the OT side device.

To solve this issue, there is a demand to incorporate a retransmission mechanism into a data diode that prevents the occurrence of missing data while the security provided by the data diode is maintained.

### SUMMARY

A data diode according to the disclosure includes: a transmission side device, transmitting data from a control side device connected to a control network; a reception side device, transmitting input data to a business network; and a one-way communication part, transmitting data transmitted from the transmission side device to the reception side device. The reception side device includes: an abnormality detection part, detecting the presence or absence of an abnormality in data transfer; and a reception side notification part, based on the presence or absence of an abnormality in data transfer detected by the abnormality detection part, notifying the transmission side device of information indicating the presence or absence of an abnormality in the data transfer. The transmission side device includes: a transmission side notification part, based on the information indicating the presence or absence of an abnormality in the data transfer notified by the reception side notification part, in a case where there is an abnormality in the data transfer, notifying the control side device of the abnormality in the data transfer.

### BRIEF DESCRIPTION OF THE DRAWINGS

FIG. 1 is a diagram showing a configuration example of a data transfer system including a data diode according to Embodiment 1.

FIG. 2 is a time chart showing an operation example of the data transfer system according to Embodiment 1, and is a time chart showing an operation example during normal operation.

FIG. 3 is a time chart showing an operation example of the data transfer system according to Embodiment 1, and is a time chart showing an operation example in the case of abnormality (in the case of abnormality in a third data transfer).

FIG. 4 is a time chart showing an operation example of the data transfer system according to Embodiment 1, and is a time chart showing another operation example in the case of abnormality (in the case of abnormality in the third data transfer).

FIG. 5 is a time chart showing an operation example of the data transfer system according to Embodiment 1, and is a time chart showing an operation example in the case of abnormality (in the case of abnormality in a second data transfer).

### DESCRIPTION OF THE EMBODIMENTS

The disclosure provides a data diode that makes it possible to transmit, from a business network side to a control network side, information indicating whether data transfer is normal or abnormal.

According to the disclosure, with a configuration as described above, it is possible to transmit, from the business network side to the control network side, the information indicating whether data transfer is normal or abnormal.

The following describes an embodiment in detail with reference to the drawings.

### Embodiment 1

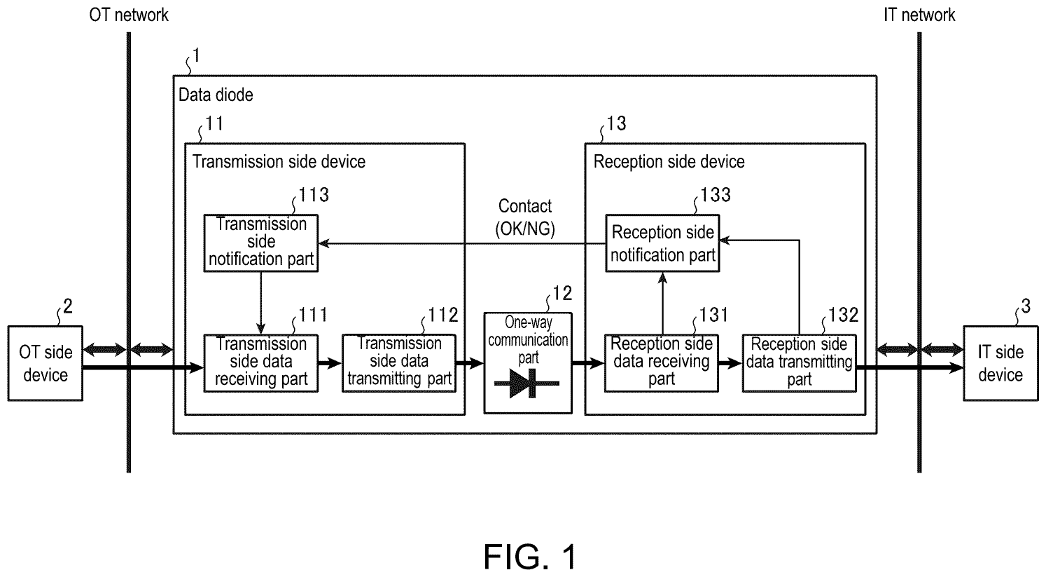

FIG. 1 is a diagram showing a configuration example of a data transfer system including a data diode 1 according to Embodiment 1. In FIG. 1, a bidirectional arrow indicates a network connection, and a unidirectional bold arrow indicates a direction of data.

The data transfer system includes, for example as shown in FIG. 1, a data diode 1, an OT side device (control side device) 2, and an IT side device (business side device) 3.

The data diode 1 is, for example as shown in FIG. 1, installed between an OT network (control network) and an IT network (business network), and is a device that performs one-way communication from the OT network to the IT network.

That is, in the data diode 1, information can be sent from the OT network to the IT network, but cannot be sent from the IT network to the OT network.

The data diode 1 according to Embodiment 1 aims to realize a necessary function without creating an information transmission path in a reverse direction. Here, the necessary function refers to a function of, when an abnormality occurs in data transfer, notifying the OT network side of the occurrence of the abnormality in data transfer from the IT network side. That is, the aim is to realize this function, which is taken for granted in normal communication, even in the data diode 1 in which information transmission in the reverse direction is not possible.

A configuration example of the data diode 1 will be described later.

The OT side device 2 is connected to, for example as shown in FIG. 1, the OT network. The OT side device 2 transmits data intended to be sent to the IT side device 3 to the data diode 1.

Generally, the OT side device 2 is a personal computer (PC) or the like, and is able to connect to a network such as Ethernet and communicate using a protocol such as TCP/IP.

The IT side device 3 is connected to, for example as shown in FIG. 1, the IT network. The IT side device 3 receives data from the OT side device 2 via the data diode 1.

Generally, the IT side device 3 is a PC or the like, and is able to connect to a network such as Ethernet and communicate using a protocol such as TCP/IP.

Next, a configuration example of the data diode 1 is described.

The data diode 1 includes, for example as shown in FIG. 1, a transmission side device 11, a one-way communication part 12, and a reception side device 13.

The transmission side device 11 is connected to the OT network, and transmits data from the OT side device 2 connected to the OT network to the one-way communication part 12.

The transmission side device 11 includes, for example as shown in FIG. 1, a transmission side data receiving part 111, a transmission side data transmitting part 112, and a transmission side notification part 113.

The transmission side data receiving part 111 receives data from the OT side device 2 connected to the OT network.

The transmission side data transmitting part 112 transmits the data received by the transmission side data receiving part 111 to the one-way communication part 12.

In the case where a reception side data receiving part 131 described later also functions as an abnormality detection part, the transmission side data transmitting part 112 adds an error detection code such as parity or cyclic redundancy check (CRC) to the data received by the transmission side data receiving part 111, and then transmits the same to the one-way communication part 12.

Based on information indicating the presence or absence of an abnormality in data transfer notified by a reception side notification part 133 described later, in the case where there is an abnormality in the data transfer, the transmission side notification part 113 notifies the OT side device 2 of the abnormality in the data transfer via the transmission side data receiving part 111.

The one-way communication part 12 transmits data from the transmission side device 11 to the reception side device 13.

The reception side device 13 is connected to the IT network, and transmits data from the transmission side device 11 via the one-way communication part 12 to the IT side device 3 connected to the IT network.

The reception side device 13 includes, for example as shown in FIG. 1, the reception side data receiving part 131, a reception side data transmitting part 132, and the reception side notification part 133.

The reception side data receiving part 131 receives data from the transmission side device 11 via the one-way communication part 12.

The reception side data transmitting part 132 transmits data received by the reception side data receiving part 131 to the IT side device 3 connected to the IT network.

At least one of the reception side data receiving part 131 and the reception side data transmitting part 132 also functions as the abnormality detection part.

The abnormality detection part detects the presence or absence of an abnormality in data transfer.

Here, if the reception side data receiving part 131 also functions as the abnormality detection part, the reception side data receiving part 131 detects the presence or absence of an abnormality in transfer (abnormality in a second data transfer to be described later) of data received from the transmission side device 11 via the one-way communication part 12. On this occasion, the reception side data receiving part 131 detects whether an error has occurred in data received based on the error detection code added to the data, thereby detecting the presence or absence of an abnormality in transfer of the data.

Information indicating the presence or absence of an abnormality in data transfer detected by the reception side data receiving part 131 is notified to the reception side notification part 133.

If the reception side data transmitting part 132 also functions as the abnormality detection part, the reception side data transmitting part 132 detects the presence or absence of an abnormality in transfer (abnormality in a third data transfer to be described later) of data transmitted to the IT side device 3. On this occasion, in the case where an error or the like occurs in data transfer, the reception side data transmitting part 132 retransmits data as appropriate. If the data still cannot be correctly transmitted by retransmission, the reception side data transmitting part 132 detects that an abnormality has occurred in transfer of the data.

Information indicating the presence or absence of an abnormality in data transfer detected by the reception side data transmitting part 132 is notified to the reception side notification part 133.

The example of FIG. 1 shows a case where both the reception side data receiving part 131 and the reception side data transmitting part 132 also function as the abnormality detection part.

In the case where information indicating the presence or absence of an abnormality in data transfer is notified by at least one of the reception side data receiving part 131 and the reception side data transmitting part 132, the reception side notification part 133 notifies the information indicating the presence or absence of an abnormality in the data transfer to the transmission side notification part 113.

Here, examples of data transfer in the data diode 1 may include three data transfers.

The first is data transfer (first data transfer) from the OT side device 2 to the transmission side device 11 in the data diode 1. In the first data transfer, a protocol such as TCP/IP may be generally employed.

The second is data transfer (second data transfer) from the transmission side device 11 to the reception side device 13 via the one-way communication part 12 within the data diode 1. The second data transfer is data transfer using the one-way communication part 12, in which the protocol does not matter if data can be reliably sent.

The third is data transfer (third data transfer) from the reception side device 13 in the data diode 1 to the IT side device 3. In the third data transfer, a protocol such as TCP/IP may be generally employed.

Among the above three data transfers, the first data transfer is TCP/IP communication on the OT network and is connection-oriented communication. Hence, if an error or the like occurs, retransmission may be performed as appropriate.

If data still cannot be correctly transmitted by retransmission, the OT side device 2 being a transmission source is able to know that transmission cannot be performed. Hence, if an abnormality occurs in the first data transfer, the OT side device 2 is able to take measures such as recording in a log or issuing an alert. This point is the same as in conventional technology.

On the other hand, among the above three data transfers, the second data transfer is communication using the one-way communication part 12. Hence, if data cannot be correctly transferred, the occurrence of abnormality basically cannot be conveyed to the transmission side device 11 being a transmission source.

In contrast, by adding an error detection code such as parity or CRC in advance when sending data from the transmission side device 11 (transmission side data transmitting part 112), it is possible to detect the occurrence of an error in the data in the reception side device 13 (reception side data receiving part 131). Thus, in the data diode 1 according to Embodiment 1, in the case where an error is detected, the fact that an abnormality has occurred in data transfer can be conveyed to the reception side notification part 133 by the reception side data receiving part 131. The reception side notification part 133 conveys, to the transmission side notification part 113, as contact information, the fact that an abnormality has occurred in data transfer. The transmission side notification part 113 conveys to the OT side device 2 via the transmission side data transmitting part 112 the fact that the data currently being transferred cannot be correctly transmitted.

Among the above three data transfers, the third data transfer is TCP/IP communication on the IT network and is connection-oriented communication. Hence, if an error or the like occurs, retransmission may be performed as appropriate.

If data still cannot be correctly transmitted by retransmission, the reception side device 13 (reception side data transmitting part 132) being a transmission source is able to know that transmission cannot be performed. Accordingly, in the data diode 1 according to Embodiment 1, in the case where data cannot be transmitted, this fact can be conveyed to the reception side notification part 133 by the reception side data transmitting part 132. The reception side notification part 133 conveys, to the transmission side notification part 113, as contact information, the fact that an abnormality has occurred in data transfer. The transmission side notification part 113 conveys to the OT side device 2 via the transmission side data transmitting part 112 the fact that the data currently being transferred cannot be correctly transmitted.

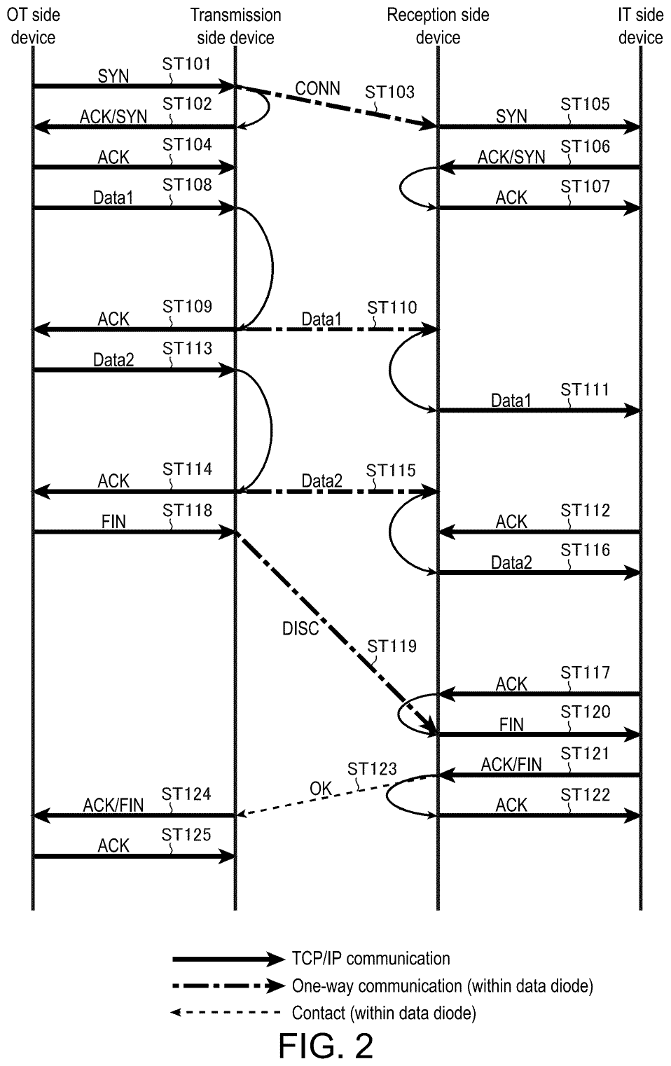

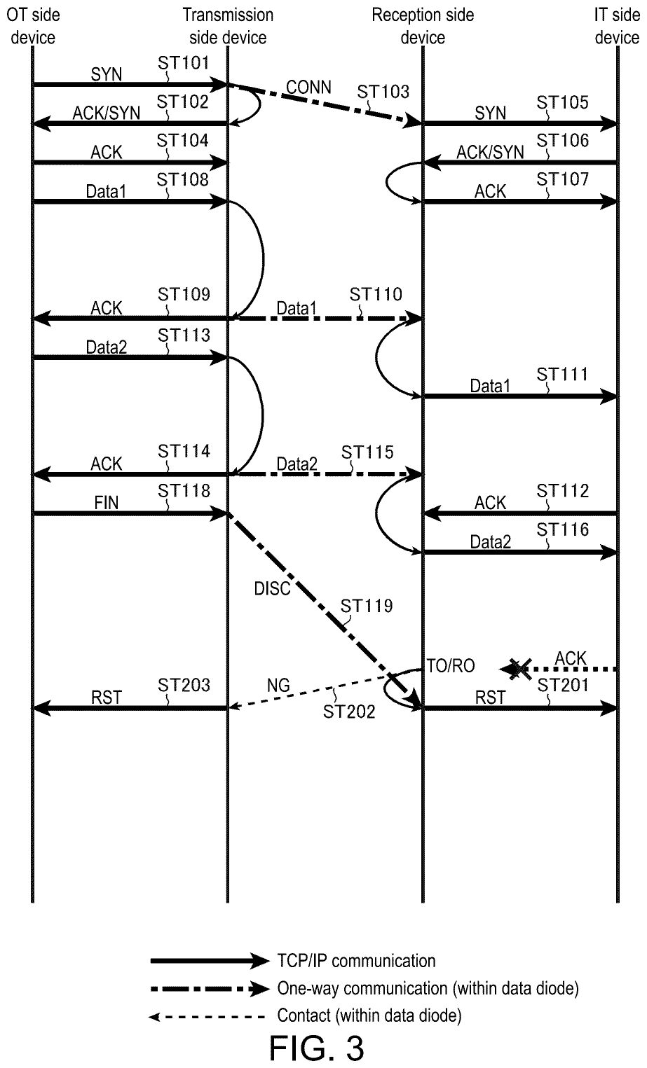

Next, an operation example of the data transfer system according to Embodiment 1 shown in FIG. 1 will be described with reference to FIG. 2 and FIG. 3. In the following, a case is shown where the OT side device 2 and the IT side device 3 are PCs and data transfer is performed using TCP/IP, TCP/IP being a connection-oriented communication protocol commonly used in PCs. In the following, a case is shown where the data diode 1 detects the presence or absence of an abnormality in the third data transfer.

FIG. 2 shows an operation example during normal operation, and FIG. 3 shows an operation example in the case of abnormality.

In the operation example of the data transfer system according to Embodiment 1 shown in FIG. 1, as shown in FIG. 2 and FIG. 3 for example, in the data transfer system, first, communication establishment processing is performed.

In the communication establishment processing, first, the OT side device 2 transmits an SYN packet to the transmission side device 11 (step ST101).

Then, in response to the SYN packet from the OT side device 2, the transmission side device 11 transmits an ACK/SYN packet to the OT side device 2 (step ST102). The transmission side device 11 transmits a CONN packet to the reception side device 13 via the one-way communication part 12 (step ST103).

Then, in response to the ACK/SYN packet from the transmission side device 11, the OT side device 2 transmits an ACK packet to the transmission side device 11 (step ST104).

In response to the CONN packet from the transmission side device 11, the reception side device 13 transmits an SYN packet to the IT side device 3 (step ST105).

Then, in response to the SYN packet from the reception side device 13, the IT side device 3 transmits an ACK/SYN packet to the reception side device 13 (step ST106).

Then, in response to the ACK/SYN packet from the IT side device 3, the reception side device 13 transmits an ACK packet to the IT side device 3 (step ST107).

Accordingly, communication is established between the OT side device 2, the data diode 1, and the IT side device 3.

Next, in the data transfer system, data transfer processing is performed.

The data diode 1 detects the presence or absence of an abnormality in data transfer. Here, by determining whether an ACK packet for data transfer has been received from the IT side device 3 within a predetermined time from the data transfer, the data diode 1 (reception side device 13) detects the presence or absence of an abnormality in data transfer (abnormality in the third data transfer).

In the examples of FIG. 2 and FIG. 3, in the data transfer system, a case is shown of transferring two pieces of data (Data1 and Data2) as data.

Here, in the example of FIG. 2, a case is shown where data is normally transferred from the reception side device 13 to the IT side device 3 for both Data1 and Data2.

In the data transfer processing during normal operation, first, the OT side device 2 transmits data to the transmission side device 11 (steps ST108 and ST113).

Then, in response to the data from the OT side device 2, the transmission side device 11 transmits an ACK packet to the OT side device 2 (steps ST109 and ST114). The transmission side device 11 transmits the above data to the reception side device 13 via the one-way communication part 12 (steps ST110 and ST115).

Then, in response to the data from the transmission side device 11, the reception side device 13 transmits the above data to the IT side device 3 (steps ST111 and ST116).

Then, in response to the data from the reception side device 13, the IT side device 3 transmits an ACK packet to the reception side device 13 (steps ST112 and ST117).

Accordingly, data transfer is performed between the OT side device 2, the data diode 1, and the IT side device 3.

In the example of FIG. 2, with respect to both Data1 and Data2, an ACK packet for data transfer is transmitted from the IT side device 3 to the reception side device 13. The data diode 1 (reception side device 13) detects that the data transfer of Data1 and Data2 has been normally performed.

On the other hand, the example of FIG. 3 shows the following case. While Data1 is normally transferred from the reception side device 13 to the IT side device 3, Data2 is not normally transferred from the reception side device 13 to the IT side device 3.

In this case, no ACK packet for the transfer of Data2 from the IT side device 3 is received by the reception side device 13 (the processing of step ST117 is not performed).

In the example of FIG. 3, with respect to Data1, an ACK packet for data transfer is transmitted from the IT side device 3 to the reception side device 13, and the data diode 1 (reception side device 13) detects that the data transfer of Data1 has been normally performed. On the other hand, with respect to Data2, no ACK packet for data transfer from the IT side device 3 is received by the reception side device 13, and the data diode 1 (reception side device 13) detects that an abnormality has occurred in the data transfer of Data2.

Next, in the data transfer system, communication termination processing is performed. If the data diode 1 detects that an abnormality has occurred in data transfer, the data diode 1 notifies the OT side device 2 of the same.

Here, in the case of normal operation as shown in FIG. 2, first, the OT side device 2 transmits an FIN packet to the transmission side device 11 (step ST118).

Then, in response to the FIN packet from the OT side device 2, the transmission side device 11 transmits a DISC packet to the reception side device 13 via the one-way communication part 12 (step ST119).

In the example of FIG. 2, since an ACK packet for data transfer has been received from the IT side device 3, in response to the DISC packet from the transmission side device 11, the reception side device 13 transmits an FIN packet to the IT side device 3 (step ST120).

Then, in response to the FIN packet from the reception side device 13, the IT side device 3 transmits an ACK/FIN packet to the reception side device 13 (step ST121).

Then, in response to the ACK/FIN packet from the IT side device 3, the reception side device 13 transmits an ACK packet to the IT side device 3 (step ST122). The reception side device 13 notifies the transmission side device 11 of normal contact information (OK information) indicating that there is no abnormality in data transfer (step ST123).

Then, in response to the normal contact information (OK information) from the reception side device 13, the transmission side device 11 transmits an ACK/FIN packet to the OT side device 2 (step ST124).

Then, in response to the ACK/FIN packet from the transmission side device 11, the OT side device 2 transmits an ACK packet to the transmission side device 11 (step ST125).

Accordingly, the communication between the OT side device 2, the data diode 1, and the IT side device 3 is terminated.

On the other hand, in the case of abnormality as shown in FIG. 3, first, the OT side device 2 transmits an FIN packet to the transmission side device 11 (step ST118).

Then, in response to the FIN packet from the OT side device 2, the transmission side device 11 transmits a DISC packet to the reception side device 13 via the one-way communication part 12 (step ST119).

In the example of FIG. 3, since no ACK packet for data transfer has been received from the IT side device 3 within a predetermined time from the data transfer, in response to the DISC packet from the transmission side device 11, the reception side device 13 transmits an RST packet to the IT side device 3 (step ST201). The reception side device 13 notifies the transmission side device 11 of abnormal contact information (NG information) indicating that there is an abnormality in the data transfer (step ST202).

Then, in response to the RST packet from the reception side device 13, the IT side device 3 cuts off the communication.

In response to the abnormal contact information (NG information) from the reception side device 13, the transmission side device 11 transmits an RST packet to the OT side device 2 (step ST203).

Then, in response to the RST packet from the transmission side device 11, the OT side device 2 cuts off the communication.

Accordingly, the communication between the OT side device 2, the data diode 1, and the IT side device 3 is forcibly terminated.

In this way, as shown in FIG. 2 for example, if no unrecoverable error has occurred in the communication during connection, after receiving normal contact information (OK information) from the reception side device 13, the transmission side device 11 transmits a packet (FIN packet) having an FIN flag that terminates connection to the OT side device 2 being a transmission source. Accordingly, in the data transfer system, the fact that the data transfer by the present connection has been normally completed can be conveyed.

On the other hand, as shown in FIG. 3 for example, if an unrecoverable error has occurred in the communication during a single connection, the reception side device 13 conveys abnormal contact information (NG information) to the transmission side device 11, and the transmission side device 11 transmits a packet (RST packet) having an RST flag to the OT side device 2 being a transmission source. Accordingly, in the data transfer system, a forced disconnection can be performed and the fact that the data transfer by the present connection has failed can be conveyed. Accordingly, it is possible for the OT side device 2 to promptly perform retransmission.

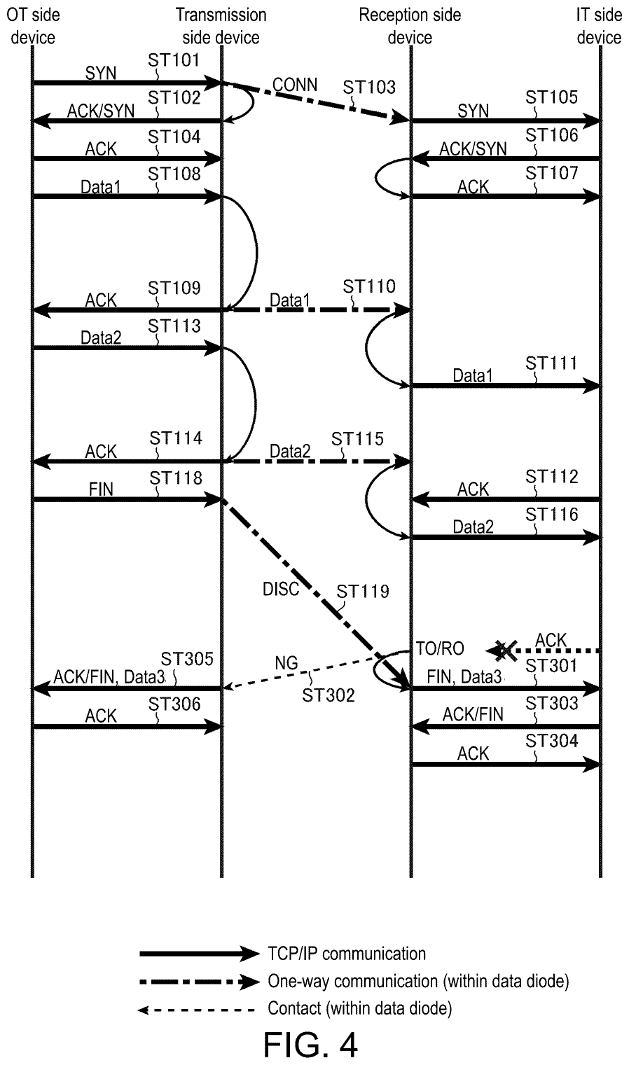

In the above, a forced disconnection using an RST packet in TCP/IP is performed in the case of occurrence of an abnormality. However, disconnection may be performed using other methods. For example, FIG. 4 shows a case where disconnection is performed using an FIN packet in the case of occurrence of an abnormality. This method utilizes the fact that arbitrary information can be conveyed to the OT side device 2 and the IT side device 3 since the connection with the OT side device 2 and the connection with the IT side device 3 use TCP/IP.

In this case, first, the OT side device 2 transmits an FIN packet to the transmission side device 11 (step ST118).

Then, in response to the FIN packet from the OT side device 2, the transmission side device 11 transmits a DISC packet to the reception side device 13 via the one-way communication part 12 (step ST119).

In the example of FIG. 4, since no ACK packet for data transfer has been received from the IT side device 3 within a predetermined time from the data transfer, in response to the DISC packet from the transmission side device 11, the reception side device 13 transmits an FIN packet added with abnormality notification data (Data3 in FIG. 4) to the IT side device 3 (step ST301). The abnormality notification data is message data for conveying an abnormality, and is data that has been predetermined as a “message in the case of occurrence of an abnormality” between the OT side device 2 and the IT side device 3. The reception side device 13 notifies the transmission side device 11 of abnormal contact information (NG information) indicating that there is an abnormality in the data transfer (step ST302).

Then, in response to the FIN packet added with abnormality notification data from the reception side device 13, the IT side device 3 transmits an ACK/FIN packet to the reception side device 13 (step ST303).

Then, in response to the ACK/FIN packet from the IT side device 3, the reception side device 13 transmits an ACK packet to the IT side device 3 (step ST304).

In response to the abnormal contact information (NG information) from the reception side device 13, the transmission side device 11 transmits an ACK/FIN packet added with abnormality notification data to the OT side device 2 (step ST305).

Then, in response to the ACK/FIN packet added with abnormality notification data from the transmission side device 11, the OT side device 2 transmits an ACK packet to the transmission side device 11 (step ST306).

Accordingly, the communication between the OT side device 2, the data diode 1, and the IT side device 3 is terminated.

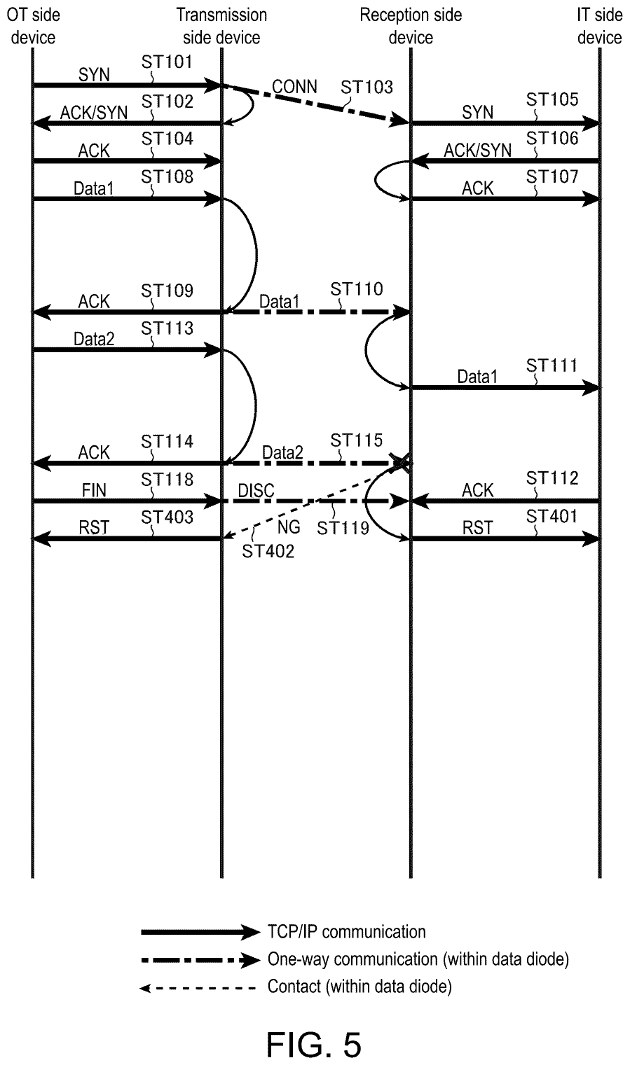

In the above, a case is shown where the data diode 1 detects the presence or absence of an abnormality in the third data transfer. In contrast, an operation example in the case of abnormality, which is a case where the data diode 1 detects the presence or absence of an abnormality in the second data transfer, is as shown in, for example, FIG. 5.

In this case, as shown in FIG. 5 for example, first, in the data transfer system, communication establishment processing is performed. This communication establishment processing is similar to the communication establishment processing shown in FIG. 2 to FIG. 4, and the description thereof is omitted.

Next, in the data transfer system, data transfer processing is performed. This data transfer processing is similar to the data transfer processing shown in FIG. 2 to FIG. 4, and the description thereof is omitted.

The data diode 1 detects the presence or absence of an abnormality in data transfer. Here, based on the error detection code included in the data from the transmission side device 11, the data diode 1 (reception side device 13) detects the presence or absence of an abnormality in data transfer (abnormality in the second data transfer).

In the example of FIG. 5, in the data transfer system, a case is shown of transferring two pieces of data (Data1 and Data2) as data.

The example of FIG. 5 shows the following case. While Data1 is normally transferred, Data2 is not normally transferred from the transmission side device 11 to the reception side device 13.

In the example of FIG. 5, the data diode 1 detects that the data transfer with respect to Data1 has been normally performed. On the other hand, the data diode 1 detects that an abnormality has occurred in the data transfer with respect to Data2.

Next, in the data transfer system, communication termination processing is performed. If the data diode 1 detects that an abnormality has occurred in data transfer, the data diode 1 notifies the OT side device 2 of the same.

In the case of abnormality as shown in FIG. 5, first, the OT side device 2 transmits an FIN packet to the transmission side device 11 (step ST118).

Then, in response to the FIN packet from the OT side device 2, the transmission side device 11 transmits a DISC packet to the reception side device 13 via the one-way communication part 12 (step ST119).

In the example of FIG. 5, since no data transfer to the IT side device 3 has been performed, in response to the DISC packet from the transmission side device 11, the reception side device 13 transmits an RST packet to the IT side device 3 (step ST401). The reception side device 13 notifies the transmission side device 11 of abnormal contact information (NG information) indicating that there is an abnormality in the data transfer (step ST402).

Then, in response to the RST packet from the reception side device 13, the IT side device 3 cuts off the communication.

In response to the abnormal contact information (NG information) from the reception side device 13, the transmission side device 11 transmits an RST packet to the OT side device 2 (step ST403).

Then, in response to the RST packet from the transmission side device 11, the OT side device 2 cuts off the communication.

Accordingly, the communication between the OT side device 2, the data diode 1, and the IT side device 3 is forcibly terminated.

In this way, in the data diode 1 according to Embodiment 1, contact information from the IT side to the OT side within the data diode 1 is prepared, making it possible to convey a data transfer state. The contact information is information for conveying to the OT side a determination result as to whether data transfer is normal or abnormal based on the communication being executed by the IT side, and various other information cannot be conveyed. The contact information is generated within the IT side of the data diode 1 and cannot be controlled by communication from the IT side.

In the data diode 1 according to Embodiment 1, if it is conveyed from the IT side to the OT side that the data transfer is normal, the OT side terminates the process normally. On the other hand, if it is conveyed from the IT side to the OT side that the data transfer is abnormal, the OT side is able to perform retransmission.

From the above, in the data diode 1 according to Embodiment 1, while security through one-way communication of the data diode 1 can be ensured, retransmission in the case of abnormality is possible.

As described above, according to Embodiment 1, the data diode 1 includes: the transmission side device 11, transmitting data from the OT side device 2 connected to the OT network; the reception side device 13, transmitting input data to the IT network; and the one-way communication part 12, transmitting data transmitted from the transmission side device 11 to the reception side device 13. The reception side device 13 includes: the abnormality detection part, detecting the presence or absence of an abnormality in data transfer; and the reception side notification part 133, based on the presence or absence of an abnormality in data transfer detected by the abnormality detection part, notifying the transmission side device 11 of information indicating the presence or absence of an abnormality in the data transfer. The transmission side device 11 includes: the transmission side notification part 113, based on the information indicating the presence or absence of an abnormality in the data transfer notified by the reception side notification part 133, in the case where there is an abnormality in the data transfer, notifying the OT side device 2 of the abnormality in the data transfer.

Accordingly, in the data diode 1 according to Embodiment 1, it is possible to transmit information indicating whether the data transfer is normal or abnormal from the IT network side to the OT network side. As a result, in the data diode 1 according to Embodiment 1, retransmission for making up for missing data is possible without creating an information transmission path in the reverse direction.

According to Embodiment 1, the reception side device 13 includes the reception side data receiving part 131 that receives data transmitted from the transmission side device 11 via the one-way communication part 12. The reception side data receiving part 131 also functions as the abnormality detection part and detects the presence or absence of an abnormality in transfer of the data received.

According to Embodiment 1, the transmission side device 11 includes the transmission side data transmitting part 112 that adds an error detection code to the data from the control side device and then transmits the same. Based on the error detection code added to the data received, the reception side data receiving part 131 detects the presence or absence of an abnormality in transfer of the data.

Accordingly, in the data diode 1 according to Embodiment 1, it is possible to transmit information indicating whether the data transfer (second data transfer) from the transmission side device 11 to the reception side device 13 within the data diode 1 is normal or abnormal.

According to Embodiment 1, the reception side device 13 includes the reception side data transmitting part 132 that transmits input data to the IT network. The reception side data transmitting part 132 also functions as the abnormality detection part and detects the presence or absence of an abnormality in transfer of the data transmitted.

Accordingly, in the data diode 1 according to Embodiment 1, it is possible to transmit information indicating whether the data transfer (third data transfer) from the reception side device 13 to the IT side device 3 in the data diode 1 is normal or abnormal.

According to Embodiment 1, a data transfer abnormality notification method is a data transfer abnormality notification method in the data diode 1. The data diode 1 includes: the transmission side device 11, transmitting data from the OT side device 2 connected to the OT network; the reception side device 13, transmitting input data to the IT network; and the one-way communication part 12, transmitting data transmitted from the transmission side device 11 to the reception side device 13. In the reception side device 13, the presence or absence of an abnormality in data transfer is detected by the abnormality detection part, and, based on the presence or absence of an abnormality in data transfer detected by the abnormality detection part, the transmission side device 11 is notified of information indicating the presence or absence of an abnormality in the data transfer by the reception side notification part 133. In the transmission side device 11, based on the information indicating the presence or absence of an abnormality in the data transfer notified by the reception side notification part 133, in the case where there is an abnormality in the data transfer, the OT side device 2 is notified of the abnormality in the data transfer by the transmission side notification part 113.

Accordingly, in the data transfer abnormality notification method according to Embodiment 1, it is possible to transmit information indicating whether data transfer is normal or abnormal from the IT network side to the OT network side. As a result, in the data transfer abnormality notification method according to Embodiment 1, retransmission for making up for missing data is possible without creating an information transmission path in the reverse direction.

Arbitrary components in the embodiment may be modified or omitted.

What is claimed is:

1. A data diode comprising:
a transmission side device, transmitting data from a control side device connected to a control network;
a reception side device, transmitting input data to a business network; and
a one-way communication part, transmitting data transmitted from the transmission side device to the reception side device, wherein
the reception side device comprises:
an abnormality detection part, detecting presence or absence of an abnormality in data transfer; and
a reception side notification part, based on the presence or absence of an abnormality in data transfer detected by the abnormality detection part, notifying the transmission side device of information indicating the presence or absence of an abnormality in the data transfer, and
the transmission side device comprises:
a transmission side notification part, based on the information indicating the presence or absence of an abnormality in the data transfer notified by the reception side notification part, in a case where there is an abnormality in the data transfer, notifying the control side device of the abnormality in the data transfer.

2. The data diode according to claim 1, wherein
the reception side device comprises:
a reception side data receiving part, receiving data transmitted from the transmission side device via the one-way communication part, wherein
the reception side data receiving part also functions as the abnormality detection part and detects the presence or absence of an abnormality in transfer of the data received.

3. The data diode according to claim 2, wherein
the transmission side device comprises:
a transmission side data transmitting part, adding an error detection code to data from the control side device and then transmitting the data; and
based on the error detection code added to the data received, the reception side data receiving part detects the presence or absence of an abnormality in the data transfer.

4. The data diode according to claim 1, wherein
the reception side device comprises:
a reception side data transmitting part, transmitting input data to a business network, wherein
the reception side data transmitting part also functions as the abnormality detection part and detects the presence or absence of an abnormality in transfer of the data transmitted.

5. The data diode according to claim 2, wherein
the reception side device comprises:
a reception side data transmitting part, transmitting input data to a business network, wherein
the reception side data transmitting part also functions as the abnormality detection part and detects the presence or absence of an abnormality in transfer of the data transmitted.

6. A data transfer abnormality notification method, used in a data diode comprising a transmission side device that transmits data from a control side device connected to a control network, a reception side device that transmits input data to a business network, and a one-way communication part that transmits data transmitted from the transmission side device to the reception side device, wherein the data transfer abnormality notification method comprises:
in the reception side device:
detecting presence or absence of an abnormality in data transfer by an abnormality detection part; and,
based on the presence or absence of an abnormality in data transfer detected by the abnormality detection part, notifying the transmission side device of information indicating the presence or absence of an abnormality in the data transfer by a reception side notification part, and
in the transmission side device:
based on the information indicating the presence or absence of an abnormality in the data transfer notified by the reception side notification part, in a case where there is an abnormality in the data transfer, notifying the control side device of the abnormality in the data transfer by a transmission side notification part.
